(19) United States
(12) Patent Application Publication
(10) Pub. No.: US 2010/0145806 A1
(43) Pub. Date: Jun. 10, 2010

(54) APPARATUS AND METHOD FOR OUTDOOR ADVERTISING

(76) Inventors: Jae Hun CHOI, Daejeon (KR); Soo Jun PARK, Seoul (KR); Seon Hee PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/488,664

(22) Filed: Jun. 22, 2009

(30) Foreign Application Priority Data
Dec. 8, 2008 (KR) 10-2008-0124283

(51) Int. Cl. G06Q 30/00; G06F 17/30

(52) U.S. Cl. 705/14.64; 705/14.49; 705/3; 707/E17.02; 707/E17.017; 707/E17.044; 707/E17.004

(57) ABSTRACT

An apparatus and method for outdoor advertising are disclosed. The apparatus for outdoor advertising includes an input unit receiving data related to desired advertising, a search unit searching for an advertisement, which is highly associated with the data, and a display unit displaying the searched advertisement. The method for outdoor advertising includes receiving data related to desired advertising, searching for an advertisement, which is highly associated with the data, and displaying the searched advertisement.

### CROSS-REFERENCE TO RELATED APPLICATIONS

This application claims the priority of Korean Patent Application No. 2008-0124283 filed on Dec. 8, 2008, in the Korean Intellectual Property Office, the disclosure of which is incorporated herein by reference.

### BACKGROUND OF THE INVENTION

1. Field of the Invention

The present invention relates to an apparatus and method for outdoor advertising, and more particularly, to an apparatus and method for outdoor advertising, which can display an outdoor advertisement on an electronic display board or the like through the interaction of an Internet portal site and a user.

2. Description of the Related Art

Advertising techniques have diversified with the development of communications and electronic technologies. In particular, large outdoor advertising apparatuses such as electronic LED billboards are being increasingly installed on the outside of buildings or in city squares. These outdoor advertising apparatuses may broadcast news or advertisements, serving as effective advertising devices, especially in areas that have large floating populations.

However, the related art outdoor advertising apparatuses adopt the method of repeatedly displaying predetermined advertisements, which are registered by static programs specified by the operators of the outdoor advertising apparatuses. Also, the related art inventions, associated with outdoor advertising, have focused on developing apparatuses with regard to, for example, the brightness or structures of electronic display boards, rather than the advertising methods thereof.

Therefore, the related art apparatus and method for outdoor advertising fail to actively reflect the characteristic that outdoor advertisements based on electronic display boards are viewed mostly by floating populations in predetermined areas. For example, the related art apparatus and method for outdoor advertising only allow for the repeated display of predetermined advertisements, although viewers' interests and their desire to share them vary with temporal or environmental conditions, and the floating populations keep changing in covered areas. Therefore, the related art apparatus and method for outdoor advertising fail to cope with such changes in a flexible manner.

### SUMMARY OF THE INVENTION

An aspect of the present invention provides an apparatus and method for outdoor advertising, which can enable interaction with users.

According to an aspect of the present invention, there is provided an apparatus for outdoor advertising, including: an input unit receiving data related to desired advertising; a search unit extracting characteristics from a plurality of advertisements to establish index information about each of the characteristics, and extracting characteristics from the data to search for an advertisement, which is highly associated with the characteristics extracted from the data, using the index information; and a display unit displaying the advertisement searched by the search unit.

The data input through the input unit may be an image.

The data input through the input unit may be a moving picture.

The data input through the input unit may be a short message service (SMS) message.

The search unit may access an Internet portal site, and search for an advertisement associated with the data.

According to another aspect of the present invention, there is provided a method for outdoor advertising, the method including: receiving data related to desired advertising; extracting characteristics from a plurality of advertisements to establish index information about each of the characteristics, and extracting characteristics from the data to search for an advertisement, which is highly associated with the characteristics extracted from the data, using the index information; and displaying the searched advertisement.

The data received in the receiving of the data may be an image.

The data received in the receiving of the data may be a moving picture.

The data received in the receiving of the data may be a short message service (SMS) message.

The searching for an advertisement may include accessing an Internet portal site and searching for an advertisement associated with the data.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates the configuration of an apparatus for outdoor advertising according to an exemplary embodiment of the present invention;

FIG. 2 is a flowchart showing the operations of an apparatus for outdoor advertising, according to an exemplary embodiment of the present invention;

FIG. 3 is a flowchart showing the operations of an apparatus for outdoor advertising, according to another exemplary embodiment of the present invention;

FIG. 4 is a flowchart of the operations of an apparatus for outdoor advertising, according to another exemplary embodiment of the present invention; and

FIG. 5 is a flowchart of the operations of an apparatus for outdoor advertising, according to another exemplary embodiment of the present invention.

### DETAILED DESCRIPTION OF THE PREFERRED EMBODIMENT

Exemplary embodiments of the present invention will now be described in detail with reference to the accompanying drawings. Like reference numerals in the drawings may denote like elements.

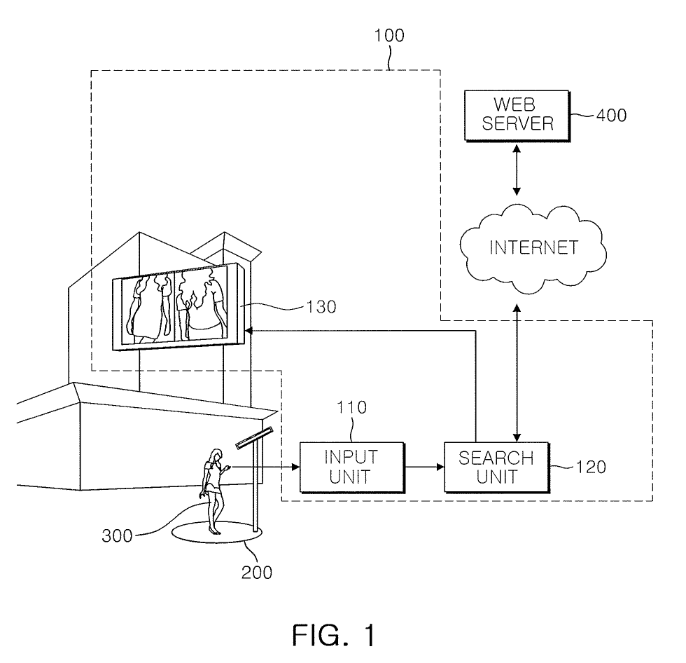

FIG. 1 illustrates the configuration of an apparatus 100 for outdoor advertising (hereinafter, referred to as ‘outdoor advertising apparatus’) according to an exemplary embodiment of the present invention. Referring to FIG. 1, the outdoor advertising apparatus 100, according to this embodiment of the present invention, includes an input unit 110 receiving data related to advertising in an advertising area 200, a search unit 120 searching for an advertisement which is associated with the input data, and a display unit 130 displaying the advertisement searched for by the search unit 120.

The advertising area 200 may be defined as an area within which an advertisement being displayed on the display unit 130 of the outdoor advertising apparatus 100 is viewable. A user 300, in this advertising area 200, inputs data related to advertising (hereinafter, referred to as ‘relevant data’) to the input unit 110 so as to view desired advertising through the display unit 130. The input operation may be performed by using a mobile phone terminal for example, and the relevant data may include a keyword, an image, a video or the like. The relevant data, input to the input unit 110, is sent to the search unit 120.

The search unit 120 searches for an advertisement which is highly associated with the relevant data it has received, from the web server 400 such as Internet portal sites. The search unit 120 outputs the advertisement searched for to the display unit 130, and the display unit 130 displays the advertisement sent from the search unit 120. The advertisement may be one that has been stored in an advertisement database (DB) of an Internet portal site, such as Google or Yahoo, or in a separately established advertisement DB.

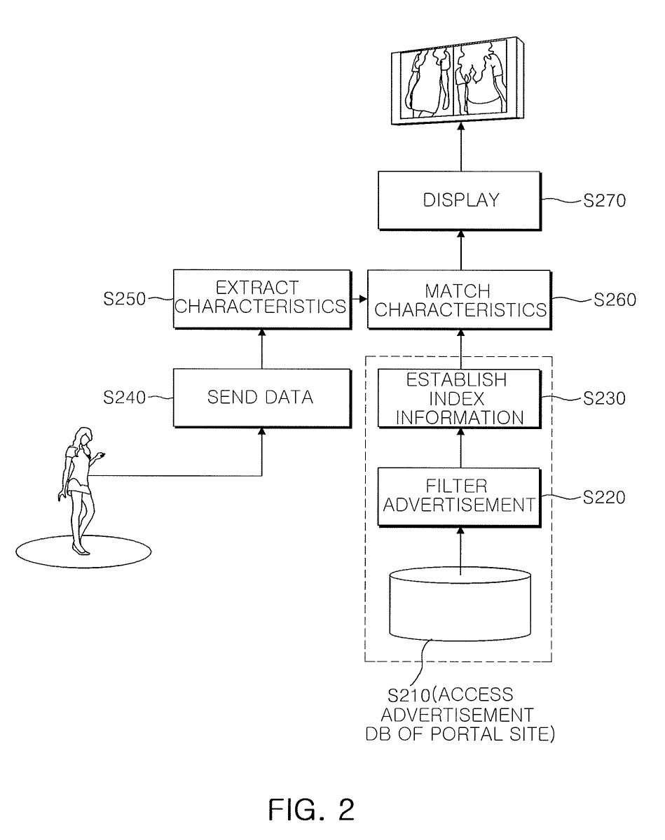

FIG. 2 is a flowchart showing the operations of the outdoor advertising apparatus 100, according to an exemplary embodiment of the present invention. In operation S210, the outdoor advertising apparatus 100 accesses an advertisement DB of a portal site. Subsequently, in operation S220, only an advertisement with a proper domain is filtered and selected out of advertisements stored in the advertisement DB. In operation S230, a variety of characteristics such as keywords are extracted from the selected advertisement, thereby establishing index information about the characteristics. When data related to advertising is received from the user 300 in operation S240, the characteristics of the received relevant data are extracted in operation S250. In operation S260, an advertisement which is most highly associated with the extracted characteristics is searched for using the index information. In operation S270, the advertisement searched for is displayed on the display unit 130. In operation S270, instead of displaying the single, most highly associated advertisement, a predefined number of advertisements that are most highly associated with the extracted characteristics may be displayed in a sequential order.

As described above, when a user 300 wants to watch desired advertising through the outdoor advertising apparatus 100, relevant data is sent to the outdoor advertising apparatus 100 through the above operations. Accordingly, the user 300 can be actively involved in viewing desired advertising through the display unit 130.

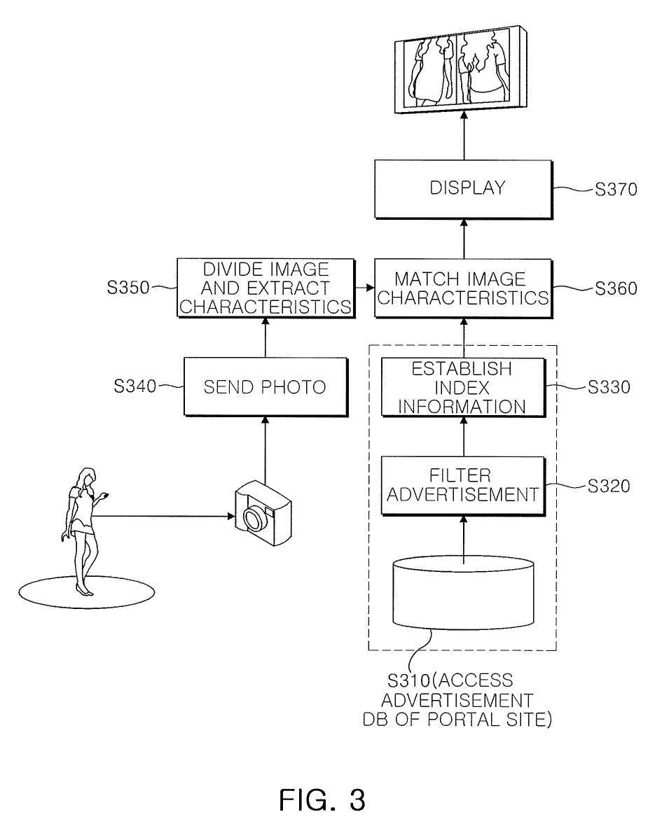

FIG. 3 is a flowchart showing the operations of the outdoor advertising apparatus 100, according to another exemplary embodiment of the present invention. This embodiment involves the case that data sent by the user 300 to the outdoor advertising apparatus 100 is an image or a picture. In operation S310, the outdoor advertising apparatus 100 accesses an advertisement DB of a portal site. In operation S320, only an advertisement with a proper domain is filtered and selected out of advertisements stored in the advertisement DB. In operation S330, a variety of characteristics such as keywords are extracted from the selected advertisement, and thus index information about the extracted characteristics is established. For example, if advertisements are moving pictures, the images of key frames are extracted, and index information is established according to a standard procedure, such as moving picture experts group (MPEG)-7. Briefly speaking, this standard procedure includes dividing an image into large blocks, extracting the characteristics of each block (e.g., edges, colors and outlines), and establishing index information about advertisements according to the extracted characteristics. If an image or a picture relevant to advertising is received from the user in operation S340, the characteristics of the received image or picture are extracted in operation S350. At this time, the characteristics may be extracted by dividing the image or picture into blocks and extracting the characteristics of each block as described above. Subsequently, in operation S360, an advertisement, which is most highly associated with the extracted characteristics, is searched for using the established index information. In operation S370, the advertisement searched for is displayed on the display unit 130. However, in operation S370, a predefined number of advertisements that are most highly associated with the extracted characteristics may be displayed in a sequential order, instead of displaying the single, most highly associated advertisement.

The relevant image or picture sent to the outdoor advertising apparatus 100 may be captured with a mobile phone terminal of the user 300 or with a camera installed in a specific area around the outdoor advertising apparatus 100. The captured image or picture may be sent to the outdoor advertising apparatus 100 through wireless or wired communication.

As an example of the application of this embodiment, the user may send an image of clothes or accessories that the user 300 is wearing, and as a result, matching clothes or accessories may be advertised through the outdoor advertising apparatus 100.

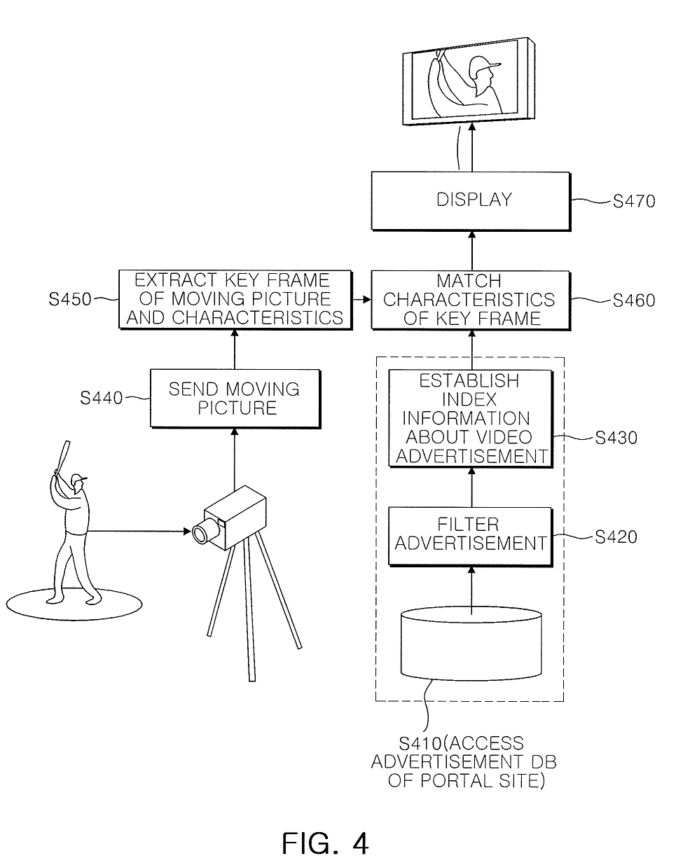

FIG. 4 is a flowchart showing the operations of the outdoor advertising apparatus 100, according to another exemplary embodiment of the present invention. This embodiment involves the case that data sent by the user 300 to the outdoor advertising apparatus 100 is a moving picture. In operation S410, the outdoor advertising apparatus 100 accesses an advertisement DB of a portal site. Subsequently, in operation S420, only an advertisement with a proper domain is filtered and selected out of advertisements stored in the advertisement DB. In operation S430, a variety of characteristics such as keywords are extracted from the selected advertisement, and thus index information about the characteristics is established. If the advertisement is a moving picture, the images of key frames are extracted and index information is established in a similar manner to the procedure described with reference to FIG. 3. Meanwhile, if a moving picture relevant to advertising is received from the user 300 in operation S440, the characteristics of the received moving picture are extracted in a similar manner in operation 450. That is, the characteristics of the moving picture from the user 300 may be extracted by extracting the key frame image of the moving picture, dividing the image into blocks and extracting the characteristics of each block as described above. Next, in operation S460, an advertisement, which is most highly associated with the extracted characteristics, is searched for using the established index information. In operation S470, the advertisement searched for is displayed on the display unit 130. However, in operation S470, a predefined number of advertisements that are most highly associated with the extracted characteristics may be displayed in a sequential order, instead of displaying the single, most highly associated advertisement.

As for an example of the application of this embodiment, if a user sends a moving picture of a soccer goal being scored to the outdoor advertising apparatus 100 at a World cup street cheering event, a TV commercial including a scene depicting the scoring of a soccer match may be displayed on the outdoor advertising apparatus.

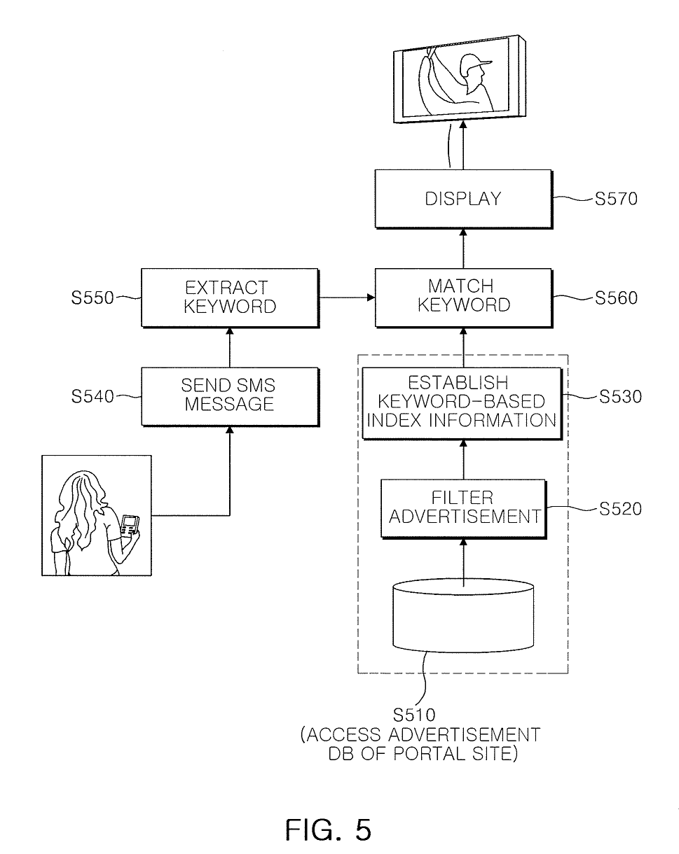

FIG. 5 is a flowchart showing the operations of the outdoor advertising apparatus 100, according to another exemplary embodiment of the present invention. This embodiment involves the case that data sent by the user 300 to the outdoor advertising apparatus 100 is a keyword. In this case, the user 300 may send the keyword by using a short message service (SMS) message of a mobile communications terminal. In operation S510, the outdoor advertising apparatus 100 accesses an advertisement DB of a portal site. Subsequently, in operation S520, only an advertisement with a proper domain is filtered and selected out of advertisements stored in the advertisement DB. In operation S530, a variety of characteristics such as keywords are extracted from the selected advertisement and index information about the characteristics is established. Meanwhile, when an SMS message is received from the user 300 in operation S540, a keyword is extracted from the received SMS message in operation S550. In operation S560, an advertisement which is most highly associated with the extracted keyword, is searched for using the established index information. In operation S570, the advertisement searched for is displayed on the display unit 130. However, in operation S570, a predefined number of advertisements that are most highly associated with the extracted keyword may be displayed in a sequential order, instead of displaying the single most highly associated advertisement.

According to the exemplary embodiments of the present invention, the user inputs information about advertising that he/she wants to watch, in an active manner, and the most suitable advertisement for the input information is searched for and displayed through the outdoor advertising apparatus. Accordingly, the user can view desired advertising instantly, interacting with the outdoor advertising apparatus.

As set forth above, according to exemplary embodiments of the invention, interaction between a user and the outdoor advertising apparatus enables the user to view desired advertising through the outdoor advertising apparatus. Accordingly, the user can easily acquire desired information through a display.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for outdoor advertising, comprising:
an input unit receiving data related to desired advertising;
a search unit extracting characteristics from a plurality of advertisements to establish index information about each of the characteristics, and extracting characteristics from the data to search for an advertisement, which is highly associated with the characteristics extracted from the data, using the index information; and
a display unit displaying the advertisement searched by the search unit.

2. The apparatus of claim 1, wherein the data input through the input unit is an image.

3. The apparatus of claim 1, wherein the data input through the input unit is a moving picture.

4. The apparatus of claim 1, wherein the data input through the input unit is a short message service (SMS) message.

5. The apparatus of claim 1, wherein the search unit accesses an Internet portal site, and searches for an advertisement associated with the data.

6. A method for outdoor advertising, the method comprising:
receiving data related to desired advertising;
extracting characteristics from a plurality of advertisements to establish index information about each of the characteristics, and extracting characteristics from the data to search for an advertisement, which is highly associated with the characteristics extracted from the data, using the index information; and
displaying the searched advertisement.

7. The method of claim 6, wherein the data received in the receiving of the data is an image.

8. The method of claim 6, wherein the data received in the receiving of the data is a moving picture.

9. The method of claim 6, wherein the data received in the receiving of the data is a short message service (SMS) message.

10. The method of claim 6, wherein the searching for an advertisement comprises accessing an Internet portal site and searching for an advertisement associated with the data.
